(19) United States
(12) Patent Application Publication
(10) Pub. No.: US 2008/0092929 A1
(43) Pub. Date: Apr. 24, 2008

(54) SUBSTRATE PROCESSING APPARATUS AND SUBSTRATE PROCESSING METHOD

(76) Inventor: Kenichi Yokouchi, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/867,916

(22) Filed: Oct. 5, 2007

(30) Foreign Application Priority Data
Oct. 19, 2006 (JP) 2006-285235
Jul. 5, 2007 (JP) 2007-177474

(51) Int. Cl. B08B 3/02

(52) U.S. Cl. 134/30; 134/95.2

(57) ABSTRACT

A substrate processing apparatus includes a substrate holding unit for holding a substrate to be processed substantially horizontally, a process liquid nozzle for supplying a process liquid to a main surface of the substrate held by the substrate holding unit, a gas nozzle for supplying an inert gas to the main surface of the substrate held by the substrate holding unit, a gas nozzle moving unit for moving the gas nozzle along the main surface, and a control unit for carrying out a liquid film forming process for forming a liquid film of the process liquid on a whole area of the main surface of the substrate held by the substrate holding unit by supplying the process liquid from the process liquid nozzle to the main surface of the substrate, and a liquid film free region forming process for forming a liquid film free region from which the liquid film is removed away in a region of the main surface not including a center of the main surface by supplying an inert gas to the main surface on which the liquid film is formed, a liquid film free region moving process for moving the liquid film free region to locate the center of the main surface in the liquid film free region by moving the gas nozzle by means of the gas nozzle moving unit with supplying the inert gas from the gas nozzle to the main surface after the liquid film free region forming process, and a substrate drying process for removing the process liquid from the main surface by spreading the liquid film free region after the liquid film free region moving process to dry the substrate.

### BACKGROUND OF THE INVENTION

1. Field of the Invention

The present invention relates to a substrate processing apparatus and a substrate processing method. Substrates to be processed include a semiconductor wafer, a substrate for a liquid crystal display, a substrate for a plasma display, a substrate for a field emission display (FED), a substrate for an optical disk, a substrate for a magnetic disk, a substrate for a magneto-optical disk, a substrate for a photo mask and the like.

2. Description of Related Arts

In a process for manufacturing semiconductor device and a liquid crystal display, cleaning process is applied to the surface of a substrate such as a semiconductor wafer and a glass substrate for the liquid crystal display. A substrate processing apparatus for cleaning a substrate includes, for example, a spin chuck for holding the substrate horizontally and rotating the same, and a cleaning liquid nozzle for supplying a cleaning liquid to the surface of the substrate held by the spin chuck. The cleaning liquid from the cleaning liquid nozzle is supplied near the rotation center of the surface of the substrate rotated by the spin chuck. The cleaning liquid from the cleaning liquid nozzle spreads on the whole area of the surface of the wafer under centrifugal force caused by the rotation of the wafer. Accordingly, a liquid film of the cleaning liquid is formed on the surface of the substrate to cover the whole area of the surface, so that the cleaning process of the surface of the substrate is carried out.

After the cleaning process is carried out, the substrate is rotated by the spin chuck at a predetermined high rotation speed. As a result, the liquid film is thrown off around the substrate and the substrate is dried. In concrete, a drying air is supplied to a central portion (the above-mentioned rotation center and its vicinity) of the surface of the substrate from a position immediately above to remove the liquid film away from the central portion, so that the substrate is dried (for example, see Japanese Unexamined Patent Publication No. 7-29866).

However, in the case of spraying air toward the central portion of substrate, liquid drops are sometimes remain near the rotation center of the substrate. Since centrifugal force is hardly applied to the portion near the rotation center, the liquid drops are caught by the drying air in the portion near the rotation center and cannot be easily removed away. Therefore, the substrate is dried with liquid drops remaining in the central portion of the surface of the substrate, so that insufficient drying such as formation of water marks is caused in the central portion of the surface of the substrate. Especially when the surface of a substrate is hydrophobic, such as a substrate processed with hydrofluoric acid and a substrate on the surface of which a Low-k layer is formed, insufficient drying is apt to occur.

### SUMMARY OF THE INVENTION

An object of the present invention is to provide a substrate processing apparatus and a substrate processing method capable of uniformly drying a substrate with restraining occurrence of insufficient drying.

A substrate processing apparatus according to the present invention comprises a substrate holding unit for holding a substrate to be processed substantially horizontally, a process liquid nozzle for supplying a process liquid to a main surface of the substrate held by the substrate holding unit, a gas nozzle for supplying an inert gas to the main surface of the substrate held by the substrate holding unit, a gas nozzle moving unit for moving the gas nozzle along the main surface, and a control unit for carrying out a liquid film forming process for forming a liquid film of the process liquid on a whole area of the main surface of the substrate held by the substrate holding unit by supplying the process liquid from the process liquid nozzle to the main surface of the substrate, and a liquid film free region forming process for forming a liquid film free region from which the liquid film is removed away in a region of the main surface not including a center of the main surface by supplying an inert gas to the main surface on which the liquid film is formed, a liquid film free region moving process for moving the liquid film free region to locate the center of the main surface in the liquid film free region by moving the gas nozzle by means of the gas nozzle moving unit with supplying the inert gas from the gas nozzle to the main surface after the liquid film free region forming process, and a substrate drying process for removing the process liquid from the main surface by spreading the liquid film free region after the liquid film free region moving process to dry the substrate.

The process liquid is supplied to the main surface of the substrate held substantially horizontally by the substrate holding unit, whereby the liquid film of the process liquid is formed on the whole area of the main surface. Thereafter, the inert gas is supplied from the gas nozzle to the main surface on which the liquid film is formed, so that the liquid film free region from which the liquid film is removed away is formed in the region of the main surface not including the center of the main surface. After the liquid film free region is formed, by moving the gas nozzle by means of the gas nozzle moving unit with supplying an inert gas from the gas nozzle to the main surface, the liquid film free region is moved to the central portion (the above-mentioned center and its vicinity) of the main surface. Accordingly, the center is located in the liquid film free region.

With this arrangement, the liquid film free region is preliminarily formed in a region not including the center of the main surface, and then the liquid film free region is moved to a region including the center of the main surface. As a result, the process liquid on the main surface can be restrained or prevented from being caught by the inert gas supplied to the main surface. Further, if liquid drops are formed on the main surface of the substrate at the time of discharging the inert gas, these liquid drops are absorbed in the liquid film on the main surface in the course of moving the liquid film free region. Therefore, the liquid drops on the main surface can be restrained from evaporation that causes insufficient drying.

After the liquid film free region is moved, by spreading the liquid film free region, the process liquid is removed away from the main surface and the substrate can be dried. At this time, the liquid film free region is located in the central portion of the main surface and no process liquid exists in the liquid film free region. Consequently, the process liquid can be surely removed away from the central portion, and at the same time insufficient drying in the liquid film free region can be restrained. As a result, with restraining insufficient drying in the main surface, the substrate can be uniformly dried.

It is preferable that the control unit supplies the process liquid from the process liquid nozzle to the main surface in the liquid film free region forming process and the liquid film free region moving process.

With this arrangement, the process liquid is supplied from the process liquid nozzle to the main surface in the liquid film free region forming process and the liquid film free region moving process. Accordingly, a large amount of the process liquid can be retained on the main surface, and such a state can be maintained that the region of the main surface other than the liquid film free region is covered with the liquid film of the process liquid. As a result, insufficient drying can be restrained by evaporation of the process liquid in that region.

Preferably, the substrate processing apparatus according to the present invention further comprises a process liquid nozzle moving unit and the above-mentioned control unit controls the process liquid nozzle moving unit to locate the process liquid nozzle to a position that the process liquid supplied from the process liquid nozzle to the main surface does not reach the liquid film free region in the liquid film free region forming process and the liquid film free region moving process. As a result, the process liquid supplied from the process liquid nozzle can be restrained or prevented from reaching the liquid film free region and liquid drops of the process liquid can be restrained or prevented from being formed in the liquid film free region. Therefore, insufficient drying due to such liquid drops can be restrained.

Further, more preferably in this case, the control unit controls the process liquid nozzle moving unit to move the process liquid nozzle in such a manner that the process liquid supply position from the process liquid nozzle to the main surface in the liquid film free region forming process and the liquid film free region moving process is located in a peripheral edge portion of the main surface (preferably, a peripheral edge portion of the main surface furthest from the liquid film free region).

By locating the process liquid supply position from the process liquid nozzle to the main surface in the peripheral edge of the main surface, the process liquid supplied from the process liquid nozzle to the main surface can be prevented from reaching the liquid film free region. As a result, insufficient drying in the liquid film free region can be prevented. In concrete, it is preferable that the process liquid from the process liquid nozzle reaches the main surface of the substrate with avoiding such a region on the main surface that the liquid film free region passes through.

Further, the control unit may control the process liquid nozzle moving unit to approximate the position of the process liquid nozzle with respect to the main surface in the liquid film free region forming process and the liquid film free region moving process to be closer than that in the liquid film forming process.

In this case, by approximating the process liquid nozzle to close to the main surface, the force of the process liquid from the process liquid nozzle with respect to the main surface in the liquid film free region forming process and the liquid film free region moving process can be more weakened than that in the liquid film forming process. Accordingly, droplets of the process liquid supplied to the main surface can be prevented from reaching the liquid film free region, so that insufficient drying can be restrained in the liquid film free region.

It is preferable that the control unit can; reduce the supply flow rate of the process liquid supplied from the process liquid nozzle to the main surface in the liquid film free region forming process and the liquid film free region moving process smaller than that in the liquid film forming process.

With this arrangement, the force of the process liquid from the process liquid nozzle with respect to the main surface in the liquid film free region forming process and the liquid film free region moving process can be more weakened than that in the liquid film forming process. As a result, droplets of the process liquid supplied to the main surface and bounced can be prevented from reaching the liquid film free region, so that insufficient drying can be restrained in the liquid film free region.

On the other hand, the control unit may control the gas nozzle to supply an inert gas to the main surface without supplying the process liquid to the main surface in the liquid film free region forming process and the liquid film free region moving process.

In this case, the process liquid is not supplied to the main surface in the liquid film free region forming process and the liquid film free region moving process. Therefore, the process liquid can be prevented from entering the liquid film free region. As a result, liquid drops of the process liquid can be restrained or prevented from being formed in the liquid film free region. Consequently, insufficient drying due to such liquid drops can be restrained.

In the liquid film free region forming process and the liquid film free region moving process, it is preferable that the substrate is rotated at a low rotation speed (for example, not higher than 50 rpm, and preferably not higher than 10 rpm), or the substrate is maintained in a stopped state. At this time, since centrifugal force is hardly applied to the liquid film on the main surface, the process liquid on the main surface is hardly scattered sideward of the substrate. Thus, the process liquid is restrained from scattering from the surface of the main surface and the liquid film is restrained from being lost from the region other than the liquid film free region. Accordingly, the process liquid supplied from the process liquid nozzle can be restrained or prevented from reaching the liquid film free region and the liquid drops of the process liquid can be prevented from being formed in the liquid film free region.

It is preferable that the liquid film free region forming process is a process for forming the liquid film free region in a region including the peripheral edge of the main surface, and that the liquid film free region moving process is a process for moving the liquid film free region from the peripheral edge of the main surface to the center thereof.

In this case, the control unit controls the gas nozzle moving unit in such a manner that the inert gas supply position from the gas nozzle to the main surface is moved from the peripheral edge of the main surface to the center thereof. That is, the liquid film free region is formed in the peripheral edge and moved toward the center.

The peripheral edge of the main surface is usually a non-device forming region in which no device is formed. Further, in the liquid film free region forming process, the inert gas supply to the main surface sometimes forms liquid drops on the main surface. As the liquid film free region moves, the liquid drops are absorbed in the liquid film on the main surface. However, the even temporary formation of the liquid drops and their starting of evaporation may cause a slight insufficient drying. Therefore, by forming the liquid film free region in the peripheral edge first, the insufficiently dried position can be located in the non-device forming region, so that the insufficient drying can be prevented in the device forming region inside the non-device forming region and the property of the device formed in the device forming region can be restrained or prevented from degradation.

Preferably, the substrate processing apparatus according to the present invention further comprises an opposing member including an opposing surface to be opposed to the main surface and a gas discharge port for discharging the inert gas to the main surface, and an opposing member moving unit for moving the opposing member, and after the liquid film free region moving process, the control unit reprocesses the gas nozzle from the substrate by means of the gas nozzle moving unit and controls the opposing member moving unit to move the opposing member, so that the opposing surface is opposed to the main surface and the inert gas is discharged from the gas discharge port, and the substrate drying process is carried out with the opposing surface being opposed to the main surface.

Accordingly, an environmental atmosphere can be prevented from entering a space between the opposing surface and the main surface, and the space can be made an inert gas atmosphere.

Further, since the substrate drying process is carried out with the opposing surface being opposed to the main surface and the space is an inert gas atmosphere, the main surface is dried under protection by the inert gas. Therefore, insufficient drying can be surely restrained in the main surface.

For the purpose of maintaining the liquid film free region on the main surface of the substrate with the inert gas supply from the gas nozzle being stopped, it is further preferable that the substrate is rotated with applying centrifugal force to the liquid film outside the liquid film free region. Further, instead of rotating the substrate, an inert gas may be discharged from the gas discharge port provided in the opposing member toward the main surface of the substrate so that the liquid film is hindered from entering the liquid film free region.

Further, the substrate processing apparatus according to the present invention may further comprises an opposing member including an opposing surface opposed to the main surface and integrated with the gas nozzle, and the control unit may, by integrally moving the gas nozzle and the opposing member by means of the gas nozzle moving unit, locate the opposing surface to be opposed to the main surface with locating the center of the main surface in the liquid film free region in the liquid film free region moving process, and carry out the substrate drying process with the opposing surface being opposed to the main surface.

With this arrangement, since the gas nozzle and the opposing member are integrated, moving of the liquid film free region and locating of the opposing surface opposed to the main surface can be carried out at the same time. Therefore, as soon as the liquid film free region moving process ends, the substrate drying process can be carried out with the opposing surface being opposed to the main surface, so that insufficient drying can be surely restrained in the main surface with restraining the processing time.

In this case, it is preferable that the inert gas supplied to the main surface in the substrate drying process contains vapor of an organic solvent having a higher volatility than that of pure water.

With this arrangement, the substrate can be dried with the main surface under protection by the inert gas and the process liquid attached to the main surface being replaced by the organic solvent. Accordingly, insufficient drying can be surely restrained in the main surface and the main surface can be rapidly dried.

Preferably, the substrate processing apparatus according to the present invention further comprises a substrate rotating unit for rotating the substrate held by the substrate holding unit, and the control unit controls the substrate rotating unit to rotate the substrate held by the substrate holding unit at a predetermined rotation speed in the substrate drying process, and with discharging the inert gas from the gas nozzle toward the main surface, moves the gas nozzle by means of the gas nozzle moving unit, so that the inert gas supply position from the gas nozzle to the main surface is moved from the center of the main surface toward the peripheral edge of the main surface to dry the substrate.

In this case, by rotating the substrate at a predetermined rotation speed by means of the substrate rotating unit, centrifugal force caused by the rotation of the substrate is applied to the liquid film formed on the main surface of the substrate. Accordingly, the annular liquid film inside which the liquid film free region is formed is brought away to the peripheral edge of the main surface and thrown off around the substrate. That is, as the liquid film is brought away to the peripheral edge of the main surface, the liquid film free region spreads toward the peripheral edge, so that the process liquid is removed away from the whole area of the main surface.

Further, the control unit controls the gas nozzle moving unit to move the gas nozzle with rotating the substrate by means of the substrate rotating unit, so that the inert gas supply position from the gas nozzle to the main surface is moved from the center to the peripheral edge. Accordingly, the liquid film free region can rapidly spread and the substrate can be dried in a shorter time.

The substrate processing method according to the present invention comprises a liquid film forming process for forming a liquid film of a process liquid on a whole area of a main surface of a substrate by supplying the process liquid to the main surface of the substrate held substantially horizontally by a substrate holding unit, a liquid film free region forming process for forming a liquid film free region from which the liquid film is removed away in a region of the main surface not including the center of the main surface by supplying an inert gas to the main surface on which the liquid film is formed, a liquid film free region moving process for moving the liquid film free region to locate the center of the main surface in the liquid film free region by moving the inert gas supply position to the main surface with supplying, after the liquid film free region forming process an inert gas to the main surface, and a substrate drying process for removing the process liquid away from the main surface by spreading the liquid film free region after the liquid film free region moving process to dry the substrate.

According to the invention, the liquid film free region is preliminarily formed in a region not including the center of the main surface, and the liquid film free region is moved to the position including the center of the main surface. Accordingly, the process liquid on the main surface can be restrained or prevented from being caught by the inert gas supplied to the main surface. Further, even if liquid drops are formed on the main surface of the substrate at the time of discharging the inert gas, the liquid drops are absorbed in the liquid film on the main surface in the course of moving the liquid film free region. Therefore, the liquid drops can be restrained or prevented from evaporation without being absorbed in the liquid film to restrain insufficient drying.

The foregoing and other objects, features and advantages of the present invention will become apparent from the following description of the embodiments given with reference to the appended drawings.

### BRIEF DESCRIPTION OF THE DRAWINGS

FIG. 1 is an illustrative view for explaining the structure of a substrate processing apparatus according to a first embodiment of the present invention;

FIG. 2 is a block diagram for explaining the electric structure of the substrate processing apparatus shown in FIG. 1;

FIG. 3 is a flow chart for showing an example of process of a wafer by means of the substrate processing apparatus shown in FIG. 1;

FIGS. 4(a) to 4(d) are illustrative views for showing the processing states in the example of FIG. 3;

FIG. 5 is an illustrative view for explaining the structure of a substrate processing apparatus according to a second embodiment of the present invention;

FIG. 6 is a flow chart for showing an example of processing a wafer by means of the substrate processing apparatus shown in FIG. 5;

FIG. 7 is an illustrative view for explaining the structure of a substrate processing apparatus according to a third embodiment of the present invention;

FIG. 8 is a flow chart for showing an example of processing a wafer by means of the substrate processing apparatus shown in FIG. 7;

FIG. 9 is a flow chart for showing an example of processing a wafer by means of the substrate processing apparatus according to a fourth embodiment of the present invention; and

FIGS. 10(a) to 10(d) are illustrative views for showing the processing states in the example of FIG. 9.

### DETAILED DESCRIPTION OF PREFERRED EMBODIMENTS

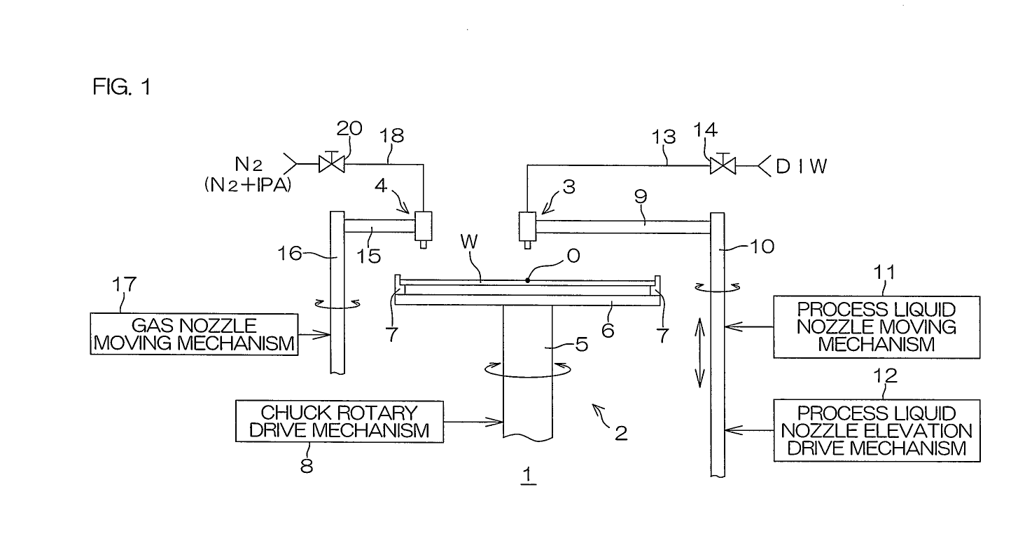

FIG. 1 is an illustrative view for explaining the structure of a substrate processing apparatus according to a first embodiment of the present invention. This substrate processing apparatus 1 is a single-substrate processing type processing apparatus for processing a semiconductor wafer (hereinafter referred only to “wafer W”) as substrates to be processed with a process liquid (a chemical or rinsing liquid such as pure water and the like). The substrate processing apparatus 1 includes a spin chuck 2 for holding a wafer W substantially horizontally and rotating the same, a process liquid nozzle 3 for supplying a process liquid to the surface (the upper surface) of the wafer W, and a gas nozzle 4 for supplying gas to the surface of the wafer W held by the spin chuck 2.

The spin chuck 2 has a rotary shaft 5 extending in the vertical direction, and a disk-shaped spin base 6 horizontally attached to the upper end portion of the rotary shaft 5. The spin chuck 2 can hold the wafer W substantially horizontally by means of a plurality of chuck pins 7 provided in an upstanding posture on the peripheral edge of the upper surface of the spin base 6.

In other words, on the peripheral edge of the upper surface of the spin base 6, the plurality of chuck pins 7 are disposed having a suitable space therebetween on a circumference corresponding to the outer peripheral edge of the wafer W. The plurality of chuck pins 7 come into contact with different positions of the peripheral edge of the back surface (the lower surface) of the wafer W, so that they cooperate with each other to clamp the wafer W and hold the same substantially horizontally.

Further, a chuck rotary drive mechanism 8 is connected to the rotary shaft 5. By inputting a drive force from the chuck rotary drive mechanism 8 to the rotary shaft 5 while the wafer W is held by the plurality of chuck pins 7, the wafer W can be rotated around a vertical axis through the center O of the surface of the wafer W.

The spin chuck 2 is not limited to one having such structure. For example, a vacuum contact type spin chuck (vacuum chuck) may be adopted which can hold a wafer w substantially horizontally by vacuum-contacting the back surface of the wafer W and rotate in this state around a vertical axis.

The process liquid nozzle 3 is, for example, a straight nozzle for discharging out a process liquid (DIW) in the form of a continuous flow. The process liquid nozzle 3, with its discharge port directed toward the wafer W (downwardly), is attached to a tip end of an arm 9 extending substantially horizontally. The arm 9 is supported by a support shaft 10 extending substantially vertically. The arm 9 is extended substantially horizontally from the upper end of the support shaft 10. The support shaft 10 is provided rotatable around its central axis.

Connected to the support shaft 10 are a process liquid nozzle moving mechanism 11 and a process liquid nozzle elevation drive mechanism 12. By rotating the support shaft 10 to substantially horizontally move the process liquid nozzle 3 by means of the process liquid nozzle moving mechanism 11, the process liquid nozzle 3 can be located above the wafer W held by the spin chuck 2 or retracted from above the wafer W. In concrete, the process liquid nozzle 3 can be moved above the wafer W in such a manner that the position on the surface of the wafer W to which the process liquid from the process liquid nozzle 3 is supplied can move with drawing circular arc trajectories between the center O and the peripheral edge of the surface of the wafer W. Further, the process liquid nozzle elevation drive mechanism 12 is provided for elevating the support shaft 10 to elevate the process liquid nozzle 3. By elevating the support shaft 10 by means of the process liquid nozzle elevation drive mechanism 12, the process liquid nozzle 3 can be brought near to the surface of the wafer W and retracted to above the spin chuck 2.

A DIW supply pipe 13 is connected to the process liquid nozzle 3. DIW (deionized water) as a rinsing liquid is supplied from the DIW supply pipe 13 to the process liquid nozzle 3. A DIW valve 14 is interposed in the DIW supply pipe 13. By opening and closing the DIW valve 14, DIW supply to the process liquid nozzle 3 is controlled.

The gas nozzle 4, with its discharge port directed toward the wafer W (downwardly), is attached to a tip end of an arm 15. The arm 15 is supported by a support shaft 16 extending substantially vertically. The arm 15 is extended substantially horizontally from the upper end of the support shaft 16. The support shaft 10 is provided rotatable around its central axis.

A gas nozzle moving mechanism 17 is connected to the support shaft 16. By rotating the support shaft 16 to substantially horizontally move the gas nozzle 4 by means of the gas nozzle moving mechanism 17, the gas nozzle 4 can be located above the wafer W held by the spin chuck 2 or retracted from above the wafer W. In concrete, the gas nozzle 4 can be moved above the wafer W in such a manner that the position on the surface of the wafer W to which gas from the gas nozzle 4 is supplied can move with drawing circular arc trajectories between the center O and the peripheral edge of the surface of the wafer W.

A nitrogen gas supply pipe 18 is connected to the gas nozzle 4. Nitrogen gas as an inert gas is supplied from the nitrogen gas supply pipe 18 to the gas nozzle 4. A nitrogen gas valve 20 is interposed in the nitrogen gas supply pipe 18. By opening and closing the nitrogen gas valve 20, nitrogen gas supply to the gas nozzle 4 is controlled.

FIG. 2 is a block diagram for explaining the electric structure of the above-mentioned substrate processing apparatus 1. The substrate processing apparatus 1 is provided with a control device 22. The control device 22 controls the operations of the chuck rotary drive mechanism 8, the process liquid nozzle moving mechanism 11, the process liquid nozzle elevation drive mechanism 12 and the gas nozzle moving mechanism 17. Further, the control device 22 controls the opening and closing of the DIW valve 14 and the nitrogen gas valve 20.

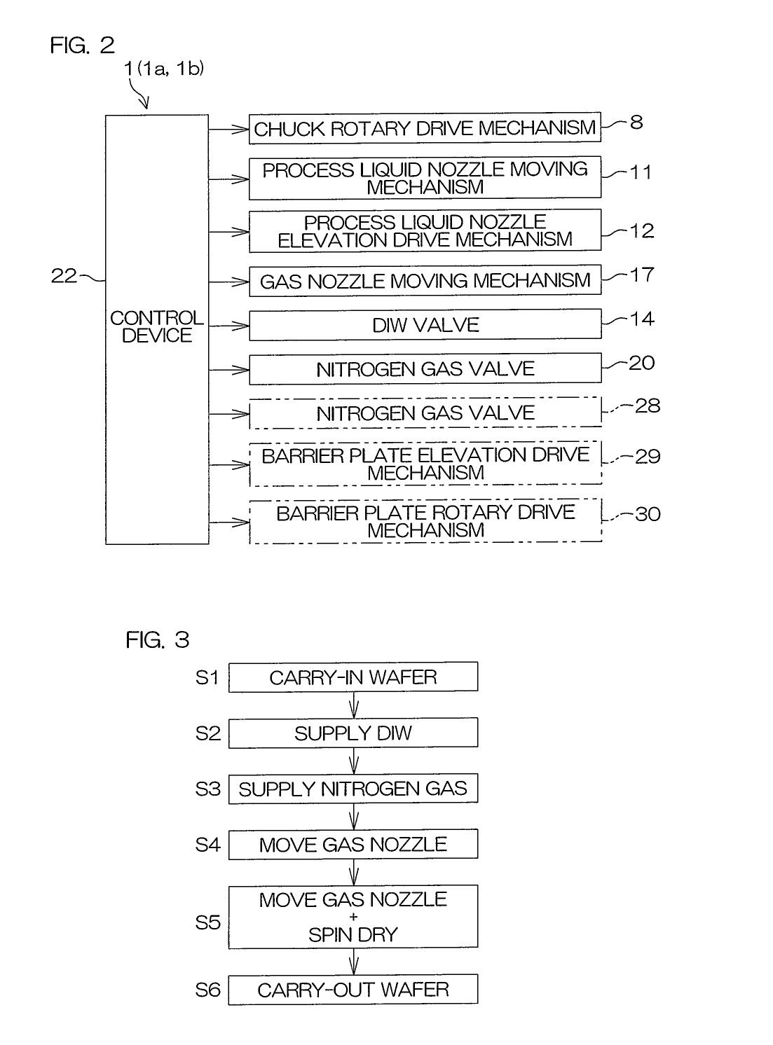

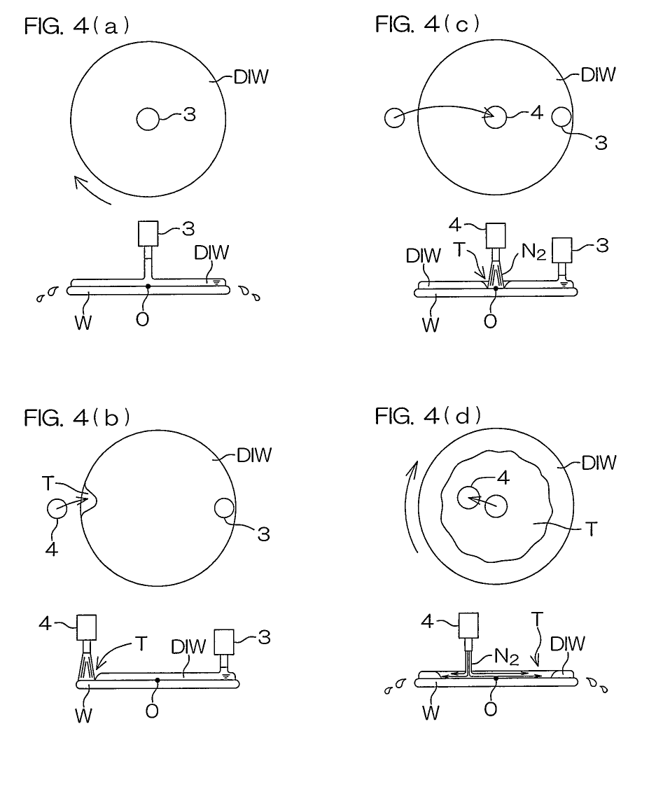

FIG. 3 is a flow chart for showing an example of process of the wafer W by means of the above-mentioned substrate processing apparatus 1. FIGS. 4(a) to 4(d) are illustrative views for showing the processing states in the example of process of the wafer W. FIGS. 4(a) to 4(d) are plan views (the upper sides) and longitudinal sectional views (the lower sides) of the wafer W in the respective processing states.

Now, referring to FIGS. 1 to 4, a case of processing a wafer W will be described in the following the surface processed with a chemical (hydrofluoric acid) and become hydrophobic.

A wafer to be processed is carried in by a transfer robot (not shown), and delivered to the spin chuck 2 (Step S1).

When the wafer W is received to the spin chuck 2, the control device 22 controls the chuck rotary drive mechanism 8 to rotate the wafer W held by the spin chuck 2 at a predetermined low rotation speed (for example, not higher than 50 rpm, and preferably, not higher than 10 rpm). Further, the control device 22 controls the process liquid nozzle moving mechanism 11 to locate the process liquid nozzle 3 above the wafer W held by the spin chuck 2.

Thereafter, the control device 22 closes the nitrogen gas valve 20 and at the same time opens the DIW valve 14, so that DIW is discharged in a first supply flow rate from the process liquid nozzle 3 toward a position near the rotation center of the surface of the wafer W (substantially the same position with the center O of the surface of the wafer W in this embodiment) as shown in FIG. 4(a)(Step S2).

The DIW supplied to the surface of the wafer W spreads on the whole area of the surface of the wafer W due to centrifugal force generated by the rotation of the wafer W. Accordingly, the surface of the wafer W is cleaned with the DIW and the whole area of the surface of the wafer W is subjected to rinsing process. Further, a DIW liquid film is formed on the surface of the wafer W to cover the whole area of the surface of the wafer W (liquid film forming process). The thickness of the liquid film is Larger than that in the case in which the surface of the wafer W is hydrophilic.

After the DIW supply is carried out for a predetermined rinsing process time, the control device 22 controls the chuck rotary drive mechanism 8 to stop the rotation of the wafer W. Further, the control device 22 changes the DIW supply flow rate from the process liquid nozzle 3 from the above-mentioned first supply flow rate to a second supply flow rate (the second supply flow rate <the first supply flow rate). Then, the control device 22 controls the process liquid nozzle moving mechanism 11 to locate the DIW supply position from the process liquid nozzle 3 to the surface of the wafer W to the peripheral edge portion of the surface. Furthermore, the control device 22 controls the process liquid nozzle elevation drive mechanism 12 to lower the process liquid nozzle 3, thereby bringing the process liquid nozzle 3 near the surface of the wafer W.

Next, the control device 22 controls the gas nozzle moving mechanism 17 to locate the gas nozzle 4 above the wafer w, and opens the nitrogen gas valve 20 to discharge nitrogen gas from the gas nozzle 4 toward the surface of the wafer W (Step S3). Then, the control device 22 controls the gas nozzle moving mechanism 17 with nitrogen gas discharged from the gas nozzle 4 to move the gas nozzle 4 above the above-mentioned rotation center (Step S4).

Accordingly, the nitrogen gas is supplied to the surface of the wafer W and at the same time the nitrogen gas supply position is moved toward the above-mentioned rotation center. In concrete, as shown in FIG. 4(b), the nitrogen gas discharged from the gas nozzle 4 is supplied to the peripheral edge of the surface first, so that the DIW is removed from that peripheral edge. That is, a liquid film free region T from which the liquid film has been removed away is formed in that peripheral edge (liquid film free region forming process). Further, as the nitrogen gas supply position on the surface is moved, the liquid film free region T is moved toward the rotation center with changing its shape from a recess-like shape formed in the peripheral edge of the liquid film to a circular shape, as shown in FIG. 4 (c). Consequently, the rotation center is located in the liquid film free region T (liquid film free region moving process) At this time, the surface of the wafer W is hydrophobic. Therefore, the liquid film free region T can be moved more easily than in the case that the surface is hydrophilic.

Further, while the gas nozzle 4 is moved to above the rotation center, the DIW is continuously discharged in the second supply flow rate from the process liquid nozzle 3 toward the surface. The DIW supply position from the process liquid nozzle 3 to the surface is located in a peripheral edge portion of the surface furthest from the liquid film free region T, namely, a peripheral edge portion opposed to the peripheral edge portion in which the liquid film free region T is formed first with the rotation center interposed therebetween. Thus, the DIW supply position is set so as to avoid the moving path of the liquid film free region T.

By forming the liquid film free region T in the peripheral edge of the surface first, the DIW can be restrained or prevented from being caught by the nitrogen gas supplied to the peripheral edge. Further, if droplets are formed at the time of nitrogen gas supply, the DIW liquid film absorbs these liquid drops as the liquid film free region T moves. Consequently, the DIW can be restrained or prevented from evaporation in the liquid film free region T that causes insufficient drying such as formation of watermarks. Further, even if insufficient drying is caused due to droplets formed at the time of first supply of nitrogen gas, the above-mentioned peripheral edge is a non-device forming region. Therefore, properties of a device formed in a device forming region inside the non-device forming region can be prevented from degradation.

Further, since the DIW is continuously discharged from the process liquid nozzle 3 toward the surface in the above-mentioned liquid film free region forming process and liquid film free region moving process, a large amount of DIW is retained on the surface. Therefore, the region other than the liquid film free region T can be kept covered with a liquid film of the process liquid. Accordingly, the DIW can be restrained from evaporation in the region other than the liquid film free region T that causes insufficient drying in this region.

Further, in the above-mentioned liquid film free region forming process and liquid film free region moving process, locating the DIW supply position from the process liquid nozzle 3 to the surface to a peripheral edge portion of the surface furthest from the liquid film free region T can restrain a part of DIW discharged from the process liquid nozzle 3 from reaching the liquid film free region T. Accordingly, the DIW can be restrained from evaporation in the liquid film free region T that causes insufficient drying in this liquid film free region T.

Furthermore, in the above-mentioned liquid film free region forming process and liquid film free region moving process, the DIW supply flow rate to the surface (the second supply flow rate) is set smaller than the supply flow rate in the liquid film forming process (the first supply flow rate). Further, the position of the process liquid nozzle 3 with respect to the surface is nearer to the surface than that in the liquid film forming process, so that the force of DIW supplied toward the surface can be reduced than that in the liquid film forming process. Accordingly, a part of DIW discharged from the process liquid nozzle 3 (especially, process liquid droplets bouncing on the surface of the wafer W) can be surely restrained from reaching the liquid film free region T.

When the liquid film free region T is moved to the central portion of the main surface (the above-mentioned rotation center and its vicinity), the control device 22 closes the DIW valve 14 to stop discharging the DIW from the process liquid nozzle 3 and at the same time controls the process liquid nozzle moving mechanism 11 to retract the process liquid nozzle 3 from above the wafer W.

Then, the control device 22 controls the chuck rotary drive mechanism 8 to acceleratingly rotate the wafer W held in a non-rotational state by the spin chuck 2 with continuously or stepwise increasing the rotation speed to a predetermined high rotation speed. Further, with discharging nitrogen gas from the gas nozzle 4, the control device 22 controls the gas nozzle moving mechanism 17 to move the gas nozzle 4 upwardly above the above-mentioned peripheral edge (Step S5).

Accordingly, centrifugal force continuously or stepwise increased by the accelerated rotation of the wafer W is applied to the above-mentioned annular liquid film inside which the liquid film free region T is located, so that the liquid film is gradually brought away to the peripheral edge and thrown off around the wafer W. Further, since the nitrogen gas supply position from the gas nozzle 4 to the surface is moved from the rotation center toward the peripheral edge of the surface, the liquid film is rapidly brought away toward the peripheral edge.

As the liquid film is brought away to the peripheral edge of the surface, the liquid film free region T spreads toward the peripheral edge, as shown in FIG. 4(d). That is, as the liquid film free region T spreads, the DIW is removed from the surface, and when the liquid film free region T spreads on the whole area of the surface, the DIW is completely removed away from the whole area of the surface. And after the DIW is completely removed away from the whole area of the surface, a minute amount of DIW attached to the surface of the wafer W is evaporated, whereby the wafer W is dried (substrate drying process).

At this time, no DIW is in the liquid film free region T, and the DIW in the central portion of the wafer W is surely removed away. Therefore, the whole area of the surface of the wafer W can be uniformly dried with restraining insufficient drying from occurring in the whole area of the surface of the wafer W. Further, since the surface of the wafer W is dried under protection by the nitrogen gas discharged from the gas nozzle 4, insufficient drying in the surface can be surely restrained.

When the DIW is removed away from the whole area of the surface and thus the surface of the wafer W is dried, the control device 22 closes the nitrogen gas valve 20 to stop discharging nitrogen gas from the gas nozzle 4. Further, the control device 22 controls the gas nozzle moving mechanism 17 to retract the gas nozzle 4 from above the wafer W. Then, the rotation speed of the wafer W is reduced and the rotation of the wafer W is stopped, and the processed wafer W is carried out from the spin chuck 2 by a transfer robot (not shown)(Step S6).

As mentioned above, in this first embodiment, forming the liquid film free region T in the peripheral edge of the surface of the wafer W can restrain or prevent the DIW from being caught by nitrogen gas supplied to the surface. Further, moving the liquid film free region T to the central portion of the surface of the wafer W can preferably remove the DIW away from the central portion. That is, with restraining or preventing insufficient drying in the liquid film free region T, the DIW can be surely removed from the surface and the wafer W can be uniformly dried. Therefore, if the surface of a wafer W is hydrophilic, the surface can be uniformly dried with restraining insufficient drying.

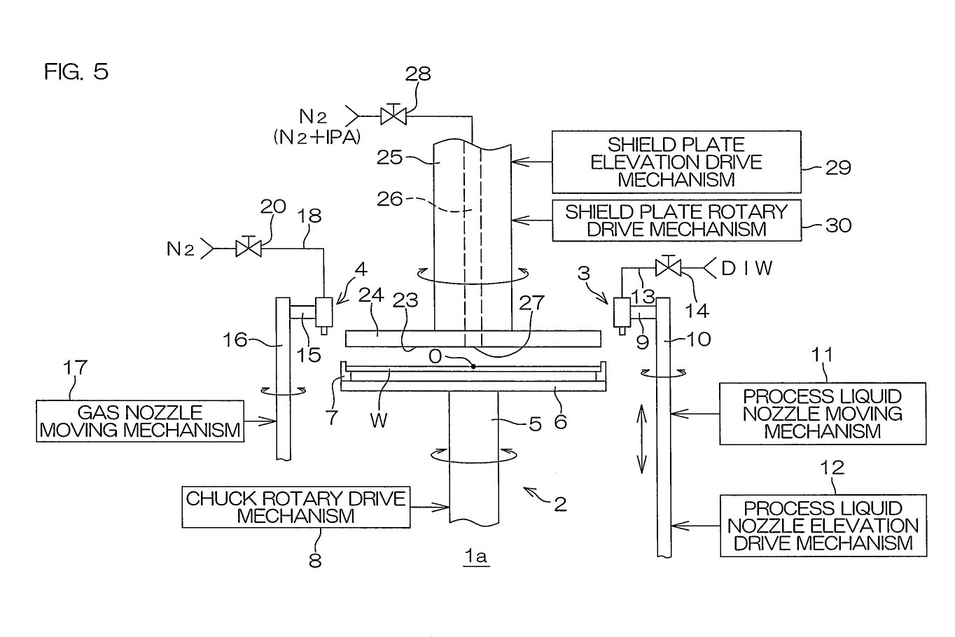

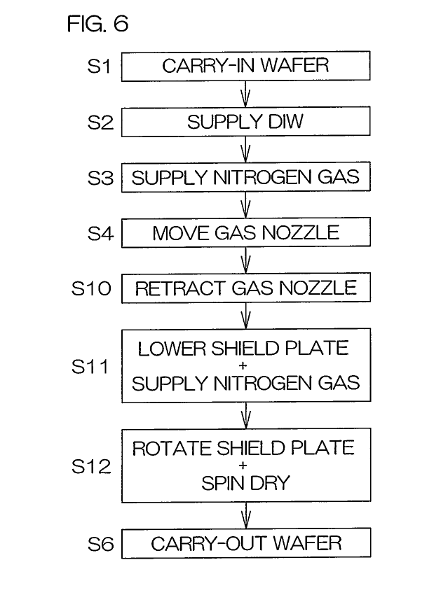

FIG. 5 is an illustrative view for explaining the structure of a substrate processing apparatus la according to a second embodiment of the present invention, and FIG. 6 is a flow chart for showing an example of processing a wafer by means of the substrate processing apparatus 1a. In FIGS. 5 and 6, parts corresponding to the parts shown in FIGS. 1 and 3 are designated with the same reference numeral therewith, and detailed description of the parts designated with the same reference numerals will be omitted in the following. Further, FIGS. 2, 5, 6 are referred to in the following.

The main difference between the structures of the substrate processing apparatus 1a shown in FIG. 5 and the substrate processing apparatus 1 shown in FIG. 1 is that shield plate 24 having an opposing surface 23 located opposed to the surface of a wafer W held by the spin chuck 2 is provided above the spin chuck 2.

In concrete, the shield plate 24 is a disk-like member having a substantially the same diameter with the wafer w (or a slightly smaller diameter than that of the wafer W). The lower surface of the shield plate 24 is the opposing surface 23. A rotary shaft 25 elongated along a vertical central axial line common with that of the rotary shaft 5 of the spin chuck 2 is fixed to the upper surface of the shield plate 24.

The rotary shaft 25 is a hollow shaft. Inside the rotary shaft 25, a gas supply path 26 is formed for supplying nitrogen gas to the surface of the wafer W. The lower end of the gas supply path 26 is opened in the opposing surface 23 to form a gas discharge port 27 for discharging nitrogen gas to the surface of the wafer W. The gas supply path 26 is supplied with nitrogen gas through a nitrogen gas valve 28.

Further, a shield plate elevation drive mechanism 29 and a shield plate rotary drive mechanism 30 are connected to the rotary shaft 25. By lifting and lowering the rotary shaft 25 and the shield plate 24 by means of the shield plate elevation drive mechanism 29, the shield plate 24 can be lifted and lowered between a close position (the position shown in FIG. 5) close to the surface of the wafer W held by the spin chuck 2 and a retraction position largely retracted above the spin chuck 2. By means of the shield plate rotary drive mechanism 30, the shield plate 24 can be rotated substantially synchronized with the rotation of the wafer W (or at a slightly different rotation speed).

In the example of processing wafer W by means of the substrate processing apparatus according to the second embodiment, the same processes with that of the wafer W by means of the above-mentioned substrate processing apparatus 1 is carried out until the liquid film free region moving process (Steps S1 to S4).

After the liquid film free region moving process, the control device 22 controls the chuck rotary drive mechanism 8 to rotate the wafer W held by the spin chuck 2 at a predetermined low rotation speed (for example, not higher than 50 rpm, and preferably, not higher than 10 rpm). Thereafter, the control device 22 Encloses the nitrogen valve 20 to stop discharging nitrogen gas from the gas nozzle 4, and controls the gas nozzle moving mechanism 17 to retract the gas nozzle 4 from above the wafer W (Step S10). At this time, the wafer W is rotated at the above-mentioned predetermined low rotation speed. Therefore, the annular liquid film is retained around the liquid film free region T under centrifugal force caused by the above-mentioned rotation. Consequently, the liquid film free region T is retained in the central portion.

Next, the control device 22 controls the shield plate elevation drive mechanism 29 to lower the shield plate 24, so that the opposing surface 23 is located to be opposed to and close to the surface of the wafer W. Further, the control device 22 opens the nitrogen gas valve 28 to supply nitrogen gas to the gas supply path 26 and discharge nitrogen gas from the gas discharge port 27 to the surface of the wafer W (Step S11). Accordingly, an environmental atmosphere is prevented from entering a space between the opposing surface 23 and the surface of the wafer W, and this space becomes a nitrogen gas atmosphere.

Then, with maintaining the opposing surface 23 being opposed to the surface of the wafer W, the control device 22 acceleratingly rotates the wafer W held by the spin chuck 2 with continuously or stepwise increasing the rotation speed from the above-mentioned predetermined low rotation speed to a predetermined high rotation speed. Further, the control device 22 controls the shield plate rotary drive mechanism 30 to rotate the shield plate 24 synchronized with the rotation of the wafer W (or at a slightly different rotation speed) (Step S12).

Accordingly, in accordance with the rotation of the wafer W and the shield plate 24, the nitrogen gas discharged from the gas discharge port 27 spreads toward the peripheral edge of the surface. Centrifugal force continuously or stepwise increased by the accelerated rotation of the wafer W is applied to the liquid film, so that the liquid film is gradually brought away to the peripheral edge and thrown off around the wafer W. Therefore, the surface of the wafer W is dried under protection by the nitrogen gas (substrate drying process).

When the DIW is removed away from the whole area of the surface and thus the surface of the wafer W is dried, the control device 22 closes the nitrogen gas valve 28 to stop discharging nitrogen gas from the gas nozzle 27. Further, the control device 22 controls the shield plate rotary drive mechanism 30 to stop the rotation of the shield plate 24, and controls the-shield plate elevation drive mechanism 29 to retract the shield plate 24 largely above the spin chuck 2. Then, the rotation speed of the wafer W is reduced and the rotation of the wafer W is stopped, and the processed wafer W is carried out from the spin chuck 2 by a transfer robot (not shown) (Step S6).

As mentioned above, in this second embodiment, with the opposing surface 23 being opposed to and close to the surface of the wafer W, and maintaining a nitrogen gas atmosphere in the space between the opposing surface 23 and the surface of the wafer W, the surface of the wafer W can be dried. Accordingly, the surface can be surely protected by nitrogen gas, so that the insufficient drying of the surface can be surely restrained and the surface can be uniformly dried.

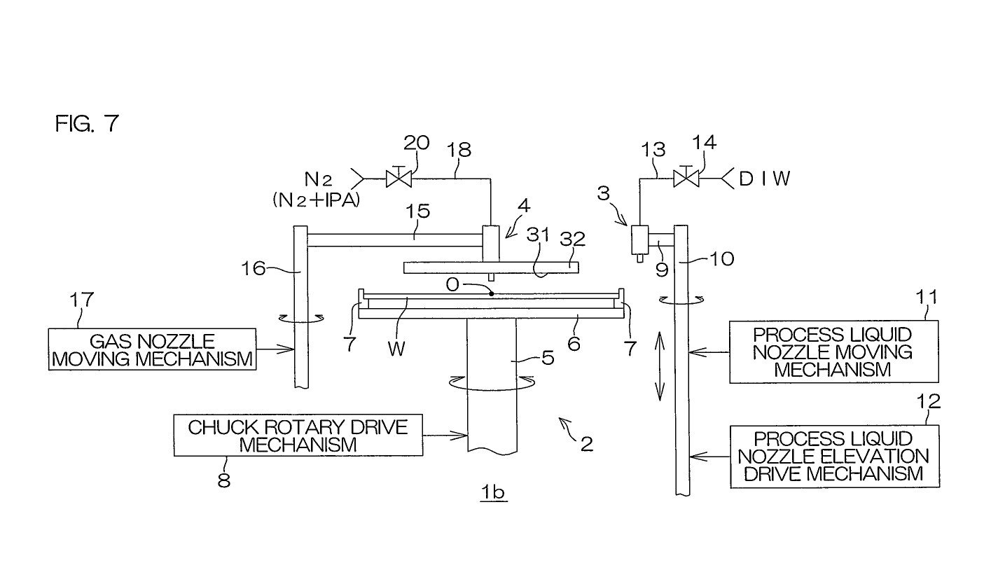

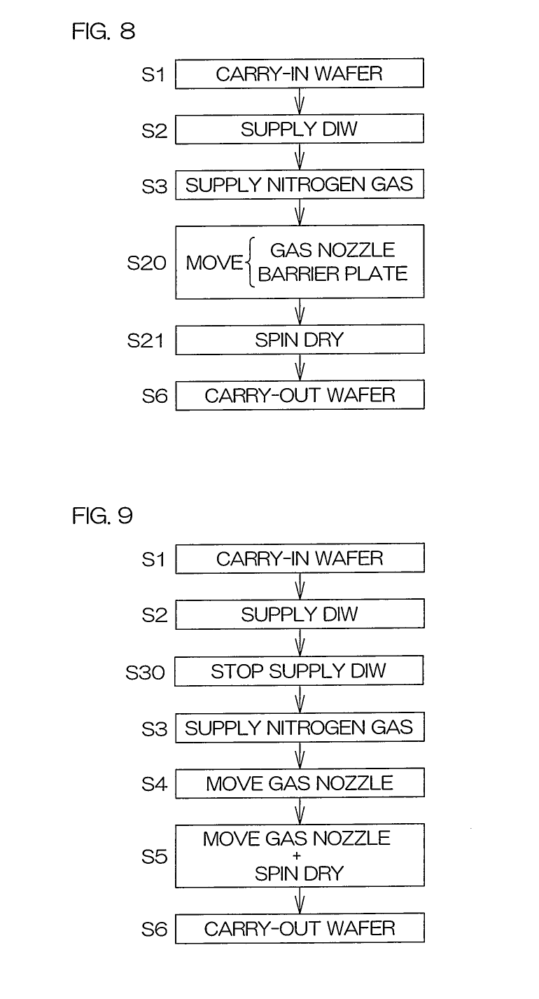

FIG. 7 is an illustrative view for explaining the structure of a substrate processing apparatus 1b according to a third embodiment of the present invention, and FIG. 8 is a flow chart for showing an example of processing a wafer by means of the substrate processing apparatus 1b. In FIGS. 7 and 8, parts corresponding to the parts shown in FIGS. 1 and 3 are designated with the same reference numeral therewith, and detailed description of the parts designated with the same reference numerals will be omitted in the following. Further, FIGS. 3, 7, 8 are referred to in the following.

The main difference between the structures of the substrate processing apparatus 1b shown in FIG. 7 and the substrate processing apparatus 1 shown in FIG. 1 is that a shield plate 32 having an opposing surface 31 to be located so as to be opposed to the surface of a wafer W held by the spin chuck 2 is attached to the end of the gas nozzle 4.

In concrete, the shield plate 32 is a disk-like member having a smaller diameter than that of the wafer w (or substantially the same diameter with the wafer W). The lower surface of the shield plate 32 is the opposing surface 31. The shield plate 32 is fixed to the gas nozzle 4 to be coaxial with the gas nozzle 4 (that is, the central axial lines of the gas nozzle 4 and the shield plate 32 are coaxial).

The gas nozzle 4 and the shield plate 32 are integrally moved substantially horizontally by means of the gas nozzle moving mechanism 17. By locating the gas nozzle 4 above the wafer W held by the spin chuck 2, the opposing surface 31 can be located to be opposed to and close to the surface of the wafer W (see FIG. 7).

In an example of processing wafer W by means of the substrate processing apparatus according to this third embodiment, the same processes with that of the wafer W by means of the above-mentioned substrate processing apparatus 1 is carried out until the liquid film free region forming process (Steps S1 to S3).

After the liquid film free region forming process, the control device 22 controls the gas nozzle moving mechanism 17 to integrally move the gas nozzle 4 and the shield plate 32 substantially horizontally, and, with moving the liquid film free region T toward the central portion of the surface, locates the opposing surface 31 to be opposed to and close to the surface of the wafer W (Step S20, liquid film free region moving step). Accordingly, an environmental atmosphere is prevented from entering a space between the opposing surface 31 and the surface of the wafer W, and this space becomes a nitrogen gas atmosphere.

Then, with maintaining the opposing surface 31 being opposed to the surface of the wafer W, the control device controls the chuck rotary drive mechanism 8 to acceleratingly rotate the wafer W held in a non-rotational state by the spin chuck 2 with continuously or stepwise increasing the rotation speed from the above-mentioned predetermined low rotation speed to a predetermined high rotation speed (Step S21). Accordingly, centrifugal force continuously or stepwise increased by the accelerated rotation of the wafer W is applied to the liquid film, so that the liquid film is gradually brought away to the peripheral edge and thrown off around the wafer W. Therefore, the surface of the wafer W is dried with being protected by nitrogen gas (substrate drying process). At this time, similarly to the case of the first embodiment, the gas nozzle 4 and the shield plate 32 may be integrally moved toward the radius of rotation outwardly.

When the DIW is removed away from the whole area of the surface and thus the surface of the wafer W is dried, the control device 22 closes the nitrogen gas valve 20 to stop discharging nitrogen gas from the gas nozzle 4. Further, the control device 22 controls the gas nozzle moving mechanism 17 to retract the gas nozzle 4 and the shield plate 32 from above the wafer W. Then, the rotation speed of the wafer W is reduced and the rotation of the wafer W is stopped, and the processed wafer W is carried out from the spin chuck 2 by a transfer robot (not shown)(Step S6).

As mentioned above, in this third embodiment, by integrally moving the integrated gas nozzle 4 and shield plate 32 by means of the gas nozzle moving mechanism 17 substantially horizontally, moving of the liquid film free region T and locating the opposing surface 31 so as to be opposed to the surface of the wafer W can be carried out at the same time. Accordingly, the substrate drying process can be carried out as soon as the liquid film free region T is moved to the central portion, so that the surface can be dried with restraining the increase of the processing time of the wafer W and surely protecting the surface with the nitrogen gas.

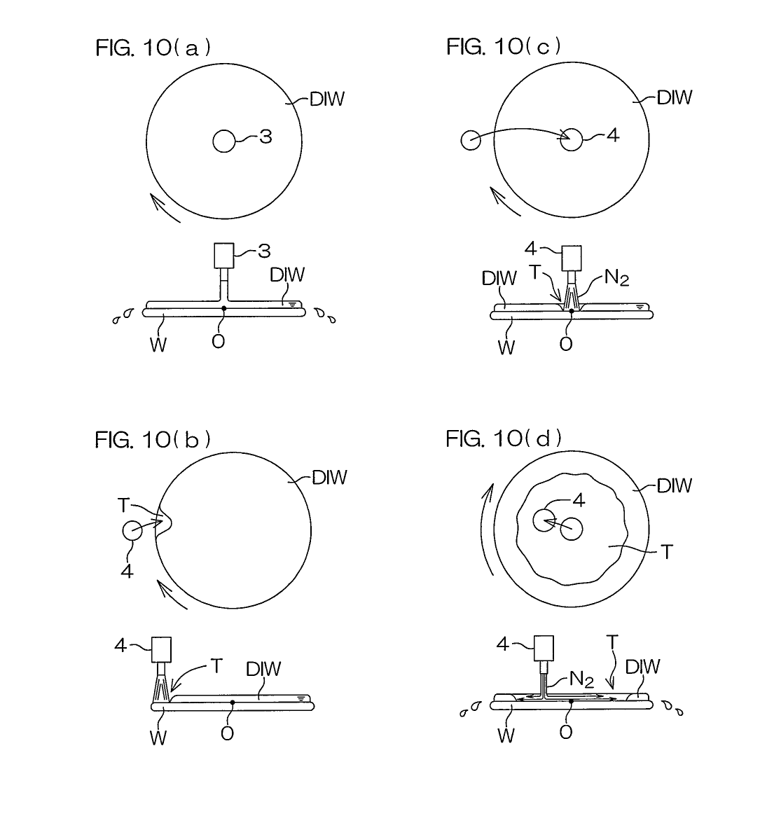

FIG. 9 is a flow chart for showing an example of processing a wafer by means of the substrate processing apparatus according to a fourth embodiment of the present invention, and FIGS. 10(a) to 10(d) are illustrative views for showing the processing states in the example of processing a wafer shown in FIG. 9. In FIGS. 9 and 10(a) to 10(d), parts corresponding to the parts of the substrate processing apparatus according to the first embodiment are designated with the same reference numeral therewith. Further, detailed description of the parts designated with the same reference numerals will be omitted in the following.

The structure of the fourth embodiment is different from that of the first embodiment in that the DIW is not supplied from the process liquid nozzle 4 to the surface of the wafer W in the liquid film free region forming process and the liquid film free region moving process.

In the example of processing wafer W by means of the substrate processing apparatus according to the fourth embodiment, the same processes with that of the example of the first embodiment is carried out until the liquid film free region forming process (Steps S1 to S4) ends (see FIG. 10(a)).

When a predetermined rinsing time passes from the start of DIW supply, the control device 22 closes the DIW valve 14 to stop DIW discharge from the process liquid nozzle 3 (Step S30) and at the same time controls the process liquid nozzle moving mechanism 11 to retract the process liquid nozzle 3 from above the wafer W to a retraction position on the side of the wafer W. The control device 22 controls the chuck rotary drive mechanism 8 to continue a rotation of the wafer W at a predetermined low rotation speed (that can hold a liquid film of DIW on the wafer W: for example, not higher than 50 rpm, and preferably, not higher than 10 rpm) Further, the control device 22 controls the gas nozzle moving mechanism 17 to locate the gas nozzle 4 to above the wafer W and opens the nitrogen gas valve 20 to discharge nitrogen gas from the gas nozzle 4 to the surface of the wafer W (Step S3). In concretes the nitrogen gas discharged from the gas nozzle 4 is supplied first to the peripheral edge of the wafer W to remove DIW from the peripheral edge of the wafer W. Accordingly, a liquid film free region T in which the liquid film is removed away is formed in the peripheral edge of the wafer W (liquid film free region T forming process, see FIG. 10 (b) ).

Then, with still opening the nitrogen gas valve 20 and discharging nitrogen gas from the gas nozzle 4, the control device 22 controls the gas nozzle moving mechanism 17 to move the gas nozzle 4 to above the rotation center of the surface of the wafer W (Step S4). Accordingly, nitrogen gas is supplied to the surface of the wafer W and at the same time, the nitrogen gas supply position is moved toward the rotation center of the surface of the wafer W. As the nitrogen supply position on the surface of the wafer W is moved, the liquid film free region T, with changing its shape from a recess-like shape formed in the peripheral edge of the liquid film to a circular shape, is moved toward the rotation center of the surface of the wafer W. As a result, the rotation center of the wafer W is located in the liquid film free region T (liquid film free region moving process, see FIG. 10(c)). Thereafter, the substrate drying process is carried out (Step S5, see FIG. 10(d)). After the substrate drying process ends, the processed wafer W is carried out by a transfer robot (not shown) (Step S6).

In this embodiment, the DIW is not supplied from the process liquid nozzle 4 to the surface of the wafer W in the liquid film free region forming process and the liquid film free region moving process. Therefore, the DIW is prevented from entering the liquid film free region T and liquid drops of the DIW are prevented or restrained from being formed in the liquid film free region T. As a result, insufficient drying is restrained in the liquid film free region T.

Further, in the liquid film free region forming process and the liquid film free region moving process, since the wafer W is rotated at a low rotation speed, centrifugal force is hardly applied to the liquid film on the wafer W. Accordingly, the DIW on the wafer W is hardly scattered sideward of the wafer W. Thus, the DIW is restrained from scattering from the surface of the wafer W and the liquid film is restrained from being lost from the region other than the liquid film free region T. Accordingly, the DIW supplied from the process liquid nozzle 3 can be restrained or prevented from reaching the liquid film free region T and liquid drops of the DIW can be prevented from being formed in the liquid film free region T. As a result, insufficient drying can be restrained in the liquid film free region T.

In the above-mentioned description, a case in which the wafer W is rotated at a low rotation speed is taken as an example. However, the rotation of the wafer W may be stopped in the liquid film free region forming process and the liquid film free region moving process. In such a case, the DIW can be more restrained from scattering from the surface of the wafer W.

Four of the embodiments of the present invention have been described in the above. However, the present invention can be embodied in other forms. For example, in the above-mentioned first to fourth embodiments, in the substrate drying process, examples are described in which mainly by acceleratingly rotating the wafer W to a predetermined high rotation speed, the liquid film is thrown off around the wafer W. However, the liquid film may be brought away to the peripheral edge of the surface to be removed away from the surface by increasing the supply flow rate of nitrogen gas supplied to the surface of the wafer W without rotating the wafer W and with rotating the wafer W at a predetermined rotation speed.

Further, in the second and third embodiments, such a structure may be adopted that DIW is not supplied to the surface of the wafer W in the liquid film free region forming process and the liquid film free region moving process.

Furthermore, in the above-mentioned first to fourth embodiments, an example is described in which nitrogen gas is supplied to the surface of the wafer W. However, the nitrogen gas supplied to the surface may contain vapor of IPA (isopropyl alcohol) which is an organic solvent having a higher volatility than that of pure water (see FIGS. 1, 5, 7).

By supplying nitrogen gas containing vapor of IPA to the surface of the wafer W, the DIW attached to the surface can be replaced by the IPA and the wafer W can be rapidly dried in the substrate drying process.

Further, in the case of supplying the nitrogen gas containing vapor of IPA to the surface of the wafer W, the liquid film of the DIW may be removed away from the surface of the wafer W to dry the wafer W by increasing the supply flow rate of the nitrogen gas containing vapor of IPA without rotating the wafer W in the substrate drying process.

Except IPA, solvents having a higher volatility than that of pure water include methanol, ethanol, acetone, HFE (hydrofluoroether) and the like.

Further, in the above-mentioned first to fourth embodiments, an example is described in which, in the liquid film free region moving process, the gas nozzle 4 is moved to above the rotation center with stopping the rotation of the spin chuck 2. However, the gas nozzle 4 may be moved with rotating the spin chuck 2 and the wafer W at a low rotation speed.

Further, in the above-mentioned first to fourth embodiments, an example is described in which, in the liquid film free region forming process, the liquid film free region T is formed in the peripheral edge of the surface of the wafer W. However, the liquid film free region T maybe formed in a region not including the center O of the surface except the peripheral edge of the surface.

Further, in the above-mentioned first to fourth embodiments, DIW is used as an example of rinsing liquid, but other rinsing liquids such as pure water, ozone water, hydrogen water and carbonic acid water may be used.

Further, in the above-mentioned first to fourth embodiments, nitrogen gas is used as an example of inert gas, but other inert gas such as argon gas may be used.

Further, in the above-mentioned first to fourth embodiments, a wafer W is used as a substrate to be processed, but other kinds of substrates such as a substrate for a liquid crystal display, a substrate for a plasma display, a substrate for a FED, a substrate for a magnetic disk, a substrate for a magneto-optical disk and a substrate for a photo mask may be processed.

Although the present invention has been described and illustrated in detail, it is clearly understood that the same is by way of illustration and example only and is not to be taken by way of limitation. The spirit and scope of the present invention is limited only by the terms of the appended claims.

This application corresponds to the Japanese Patent Application No.2006-285235 filed with the Japan Patent Office on Oct. 19, 2006 and Japanese Patent Application No.2007-177474 filed with the Japan Patent Office on Jul. 5, 2007, the disclosure of which is incorporated herein by reference in entirety.

What is claimed is:

1. A substrate processing apparatus comprising:
a substrate holding unit for holding a substrate to be processed substantially horizontally;
a process liquid nozzle for supplying a process liquid to a main surface of the substrate held by the substrate holding unit;
a gas nozzle for supplying an inert gas to the main surface of the substrate held by the substrate holding unit;
a gas nozzle moving unit for moving the gas nozzle along the main surface; and
a control unit for carrying out a liquid film forming process for forming a liquid film of the process liquid on a whole area of the main surface of the substrate held by the substrate holding unit by supplying the process liquid from the process liquid nozzle to the main surface of the substrate, a liquid film free region forming process for forming a liquid film free region from which the liquid film is removed away in a region of the main surface not including a center of the main surface by supplying an inert gas to the main surface on which the liquid film is formed, a liquid film free region moving process for moving the liquid film free region to locate the center of the main surface in the liquid film free region by moving the gas nozzle by means of the gas nozzle moving unit with supplying the inert gas from the gas nozzle to the main surface after the liquid film free region forming process, and a substrate drying process for removing the process liquid from the main surface by spreading the liquid film free region after the liquid film free region moving process to dry the substrate.

2. A substrate processing apparatus as claimed in claim 1, in which the control unit supplies the process liquid from the process liquid nozzle to the main surface in the liquid film free region forming process and the liquid film free region moving process.

3. A substrate processing apparatus as claimed in claim 2, further comprising a process liquid nozzle moving unit,
in which the control unit controls the process liquid nozzle moving unit to locate the process liquid nozzle to a position that the process liquid supplied from the process liquid nozzle to the main surface does not reach the liquid film free region in the liquid film free region forming process and the liquid film free region moving process.

4. A substrate processing apparatus as claimed in claim 3, in which the control unit controls the process liquid nozzle moving unit to move the process liquid nozzle in such a manner that the process liquid supply position from the process liquid nozzle to the main surface in the liquid film free region forming process and the liquid film free region moving process is located in a peripheral edge of the main surface.

5. A substrate processing apparatus as claimed in claim 3, in which the control unit controls the process liquid nozzle moving unit to approximate the position of the process liquid nozzle with respect to the main surface in the liquid film free region forming process and the liquid film free region moving process to be closer than that in the liquid film forming process.

6. A substrate processing apparatus as claimed in claim 2, in which the control unit reduces the supply flow rate of the process liquid supplied from the process liquid nozzle to the main surface in the liquid film free region forming process and the liquid film free region moving process smaller than that in the liquid film forming process.

7. A substrate processing apparatus as claimed in claim 1, in which the control unit controls the gas nozzle to supply an inert gas to the main surface without supplying the process liquid to the main surface in the liquid film free region forming process and the liquid film free region moving process.

8. A substrate processing apparatus as claimed in claim 1, in which the liquid film free region forming process is a process for forming the liquid film free region in a region including the peripheral edge of the main surface, and
the liquid film free region moving process is a process for moving the liquid film free region from the peripheral edge of the main surface to the center thereof.

9. A substrate processing apparatus as claimed in claim 1, further comprising an opposing member including an opposing surface to be opposed to the main surface and a gas discharge port for discharging the inert gas to the main surface, and
an opposing member moving unit for moving the opposing member,
in which after the liquid film free region moving process, the control unit reprocesses the gas nozzle from the substrate by means of the gas nozzle moving unit and controls the opposing member moving unit to move the opposing member, whereby the opposing surface is opposed to the main surface and the inert gas is discharged from the gas discharge port, and the substrate drying process is carried out with the opposing surface being opposed to the main surface.

10. A substrate processing apparatus as claimed in claim 1, further comprising an opposing member including an opposing surface opposed to the main surface and integrated with the-g*as nozzle,
in which the control unit locates, by integrally moving the gas nozzle and the opposing member by means of the gas nozzle moving unit, the opposing surface to be opposed to the main surface with locating the center of the main surface in the liquid film free region in the liquid film free region moving process, and carries out the substrate drying process with the opposing surface being opposed to the main surface.

11. A substrate processing apparatus as claimed in claim 1, in which the control unit carries out the substrate drying process with supplying the inert gas to the main surface from the gas nozzle or the gas discharge port.

12. A substrate processing apparatus as claimed in claim 11, in which the inert gas supplied to the main surface in the substrate drying process contains vapor of an organic solvent having a higher volatility than that of pure water.

13. A substrate processing apparatus as claimed in claim 1, further comprising a substrate rotating unit for rotating the substrate held by the substrate holding unit,
in which the control unit controls the substrate rotating unit to rotate the substrate held by the substrate holding unit at a predetermined rotation speed in the substrate drying process, and with discharging the inert gas from the gas nozzle toward the main surface, moves the gas nozzle by means of the gas nozzle moving unit, whereby the inert gas supply position from the gas nozzle to the main surface is moved from the center of the main surface toward the peripheral edge of the main surface to dry the substrate.

14. A substrate processing method comprising:
a liquid film forming process for forming a liquid film of a process liquid on a whole area of a main surface of a substrate by supplying the process liquid to the main surface of the substrate held substantially horizontally by a substrate holding unit;
a liquid film free region forming process for forming a liquid film free region from which the liquid film is removed away in a region of the main surface not including the center of the main surface by supplying an inert gas to the main surface on which the liquid film is formed;
a liquid film free region moving process for moving the liquid film free region to locate the center of the main surface in the liquid film free region by moving an inert gas supply position to the main surface with supplying an inert gas to the main surface after the liquid film free region forming process; and
a substrate drying process for removing the process liquid away from the main surface by spreading the liquid film free region after the liquid film free region moving process to dry the substrate.
